(19) United States
(12) Patent Application Publication
(10) Pub. No.: US 2012/0322347 A1
(43) Pub. Date: Dec. 20, 2012

(54) METHOD AND APPARATUS FOR PREPARATION OF CYLINDER BORE SURFACES WITH A PULSED WATERJET

(75) Inventors: Ronald J. Molz, Mt. Kisco, NY (US); Peter Ernst, Stadel b. Niederglatt (CH)

(73) Assignee: Sulzer Metco (US), Inc.

(21) Appl. No.: 13/499,764

(22) PCT Filed: Aug. 18, 2010
(86) PCT No.: PCT/EP10/62014

§ 371 Date: Aug. 30, 2012

Related U.S. Application Data
(60) Provisional application No. 61/249,009, filed on Oct. 6, 2009.

(51) Int. Cl. B05B 1/08; B26D 3/00; B24C 3/32; B24C 1/00

(52) U.S. Cl. 451/40; 83/53; 83/177; 451/76

(57) ABSTRACT

An apparatus for and a method of prepping a surface of a cylinder bore using a pulsed waterjet entails generating a signal having a frequency f using a signal generator, applying the signal to generate a pulsed waterjet through an exit orifice of a nozzle having an exit orifice diameter d and a length L. The pulsed waterjet prepares the surface to within a predetermined range of surface roughness. The surface roughness is determined by selecting operating parameters comprising a standoff distance (SD), a traverse velocity V_{TR} of the nozzle, a water pressure P, a water flow rate Q, a length-to-diameter (L/d) ratio, the frequency f, and an amplitude A of the signal.

### CROSS-REFERENCE TO RELATED APPLICATIONS

This is the first application filed for the present invention.

### TECHNICAL FIELD

The present invention relates generally to pulsed waterjets and, in particular, to surface preparation using pulsed waterjets, and more particularly to surface preparation of engine cylinder bores using pulse waterjets.

### BACKGROUND

Thermal spray coating of cylinder bores requires the bore surface to be prepared to accept the coating in that the surface of the bore must be free of contamination and oxides as well as have a desired range of surface roughness in order to ensure the coating adheres to the bore surface. Two methods of surface preparation are commonly used: grit blasting and high pressure water jets. Other methods include mechanical roughening using abrasive reamers, drill points, and dovetail edges.

Grit blasting uses a hard abrasive such as aluminum oxide or chilled iron particles directed at a substrate at velocities sufficient to erode the surface. This method of surface preparation suffers from the potential of entrapping some of the grit media into the substrate surface introducing a contaminant into the coating system and can also adversely affect grinding or honing of the coating after application. In addition grit blasting can result in grit particles bouncing off the substrate at high velocity penetrating seals and mechanical equipment. Grit blasting has been used in the industry for many decades to prepare surfaces for thermal spray coatings and remains the most popular method.

High pressure water jet (HPWJ), also known as continuous-flow water jet, uses a stream of water ejected from a nozzle using pressures of around 50,000 psi to erode the surface. This method is very energy intensive and also has safety issues with operating at very high pressures. HPWJ has evolved over the last 20 years.

Examples of continuous-flow, high-pressure waterjet systems for cutting and cleaning are known, for example, in U.S. Pat. Nos. 4,787,178 (Morgan et al.), 4,966,059 (Landeck), 6,533,640 (Nopwaskey et al.), 5,584,016 (Varghese et al.), 5,778,713 (Butler et al.), 6,021,699 (Caspar), 6,126,524 (Shepherd) and 6,220,529 (Xu). Further examples are found in European Patent Applications EP 0 810 038 (Munoz) and EP 0 983 827 (Zumstein), as well as in US Patent Application Publications 2002/0109017 (Rogers et al.), 2002/0124868 (Rice et al.), and 2002/0173220 (Lewin et al.).

Continuous-flow waterjet technology, of which the foregoing are examples, suffers from certain drawbacks which render continuous-flow waterjet systems expensive and cumbersome. As persons skilled in the art have come to appreciate, continuous-flow waterjet equipment must be robustly designed to withstand the extremely high water pressures involved. Consequently, the nozzle, water lines and fittings are bulky, heavy and expensive. To deliver an ultra-high-pressure waterjet, an expensive ultra-high-pressure water pump is required, which further increases costs both in terms of the capital cost of such a pump and the energy costs associated with running such a pump, as well as maintenance costs.

In response to the shortcomings of continuous-flow waterjets, an ultrasonically pulsating nozzle was developed to deliver high-frequency modulated water in non-continuous, discrete packets, or “slugs”. This ultrasonic nozzle is described and illustrated in detail in U.S. Pat. No. 5,134,347 (Vijay), that discloses transduced ultrasonic oscillations from an ultrasonic generator into ultra-high frequency mechanical vibrations capable of imparting thousands of pulses per second to the waterjet as it travels through the nozzle. These waterjet pulses impart a water hammer pressure onto the surface to be cut or cleaned. This rapid bombardment of mini-slugs of water, each imparting a water hammer pressure on the target surface, enhances the erosive capacity of the waterjet. This ultrasonically pulsating nozzle is able to cut or clean more efficiently than the prior-art continuous-flow waterjets.

Theoretically, the erosive pressure striking the target surface is the stagnation pressure, or 1−ρv², where ρ represents the water density and v represents the impact velocity of the water as it impinges on the target surface. The pressure arising due to the water hammer phenomenon, by contrast, is ρcv, where c represents the speed of sound in water, which is approximately 1524 m/s.

The theoretical magnification of impact pressure achieved by pulsating the waterjet is 2c/v. Even if air drag is neglected and the impact velocity is assumed to approximate the fluid discharge velocity of 1500 feet per second (or approximately 465 m/s), the magnification of impact pressure is about 6 to 7. When the air drag is accounted, assuming an impact velocity of about 300 m/s, the theoretical magnification would be tenfold.

In practice, due to frictional losses and other inefficiencies, the pulsating ultrasonic nozzle described in U.S. Pat. No. 5,154,347 imparts about 6 to 8 times more impact pressure onto the target surface for a given source pressure. Accordingly, to achieve the same erosive capacity, the pulsating nozzle need only operate with a pressure source that is 6 to 8 times less powerful. Since the pulsating nozzle may be used with a much smaller and less expensive pump, it is more economical than continuous-flow waterjet nozzles. Further, since waterjet pressure in the nozzle, lines, and fittings is much less with an ultrasonic nozzle, the ultrasonic nozzle can be designed to be lighter, less cumbersome and more cost-effective.

Although the ultrasonic nozzle described in U.S. Pat. No. 5,154,347 and the improved version presented in WO/2005/042177 entitled ULTRASONIC WATERJET APPARATUS, which are both hereby incorporated by reference, represent substantial breakthroughs in waterjet technology, these early technologies were not designed for surface preparation. Accordingly, a method and apparatus for preparing surfaces that improves on the prior art technology is desired. Still further, what is needed is a method of preparing cylinder bores that does not entail using high pressure water jets or dry abrasives that can be trapped into the substrate that can provide a surface profile similar to that produced with either of these methods.

### SUMMARY OF THE INVENTION

An object of the present invention is to provide a pulsed waterjet (PWJ) apparatus for surface preparation of engine cylinder bores. More specifically, the PWJ can prepare the surface of engine cylinder bores for receiving thermal spray coatings. Pulsed waterjets represent a substantial improvement over continuous plain (ultra-high pressure) waterjet technologies in terms of surface preparation performance. Pulsed waterjets can be specifically tailored to produce exact and highly uniform surface roughness characteristics by adjusting key operating parameters such as the frequency (f) and amplitude (A) of the signal that drives the transducer, the water flow rate (Q) and pressure (P), and certain key dimensions of the nozzle, such as the diameter d of the exit orifice, the ratio L/d where L represents the length of the cylindrical portion of the exit orifice, and the parameter ‘a’ where ‘a’ represents the distance from the microtip to the orifice exit. Surface roughness characteristics can also be controllably varied by adjusting operating parameters such as the standoff distance (SD) and the traverse velocity (V_{TR}). PWJ produces a highly predictable surface finish on any given material by selecting the operating parameters accordingly.

For example, one application of PWJ is in the surface preparation of the inner cylindrical surfaces of cylinder bores for engine blocks, for example aluminum engine blocks. Using PWJ, surface preparation of these cylinder bores can be efficiently accomplished, and the surfaces of these cylinder bores can be prepared to very exacting roughness requirements to optimize subsequent bonding of coatings applied using thermal spray technology. By adjusting a set of key operating parameters, namely f, A, P, Q, V_{TR}, SD, L/d, d, ‘a’, the erosive characteristics of the pulsed waterjet can be varied to suit the particular material to be eroded and, secondly, to achieve the desired rate of mass removal. In other words, by adjusting the key operating parameters (f, A, P, Q, V_{TR}, SD, L/d, d, ‘a’), a highly uniform and predictable surface roughness can be achieved with reduced pitting, gouging or other surface defects. It is also possible by adjusting the operating parameters to mostly eliminate pitting, gauging, or other surface defects.

In accordance with one aspect of the present invention, the pulsed waterjet can be generated by means of creating high-frequency pulsating liquid jets. These high-frequency liquid jets can be generated using internal mechanical flow modulators, Helmholtz oscillators, self-resonating nozzles and/or ultrasonic nozzles. Additionally, the pulsed waterjet can be made utilizing acoustic waves, for example, by generating acoustic wave by the action of an acoustic transducer on the liquid.

In accordance with one aspect of the present invention, a novel method of preparing a surface using pulsed waterjet is a high-frequency forced pulsed waterjet, comprising steps of generating a high-frequency signal having a frequency f using a high-frequency signal generator, applying the high-frequency signal to a transducer having a microtip to cause the microtip of the transducer to vibrate and thereby generate a forced pulsed waterjet through an exit orifice of a nozzle having an exit orifice diameter d and a exit orifice length L, and causing the forced pulsed waterjet to impinge upon the surface to be prepared to prepare the surface to within a predetermined range of surface roughness, wherein the predetermined range of surface roughness is determined by selecting operating parameters comprising a standoff distance (SD), a traverse velocity V_{TR} of the nozzle, a water pressure P, a water flow rate Q, an orifice length-to-diameter (L/d) ratio, a microtip-to-orifice exit plane distance (a), the frequency f, and an amplitude A of the high-frequency signal.

In accordance with another aspect of the present invention, a novel forced pulsed waterjet apparatus for surface preparation comprises a high-pressure water pump for generating a pressurized waterjet having a water pressure P and a water flow rate Q; a high-frequency signal generator for generating a high-frequency signal of frequency f and amplitude A; and an ultrasonic nozzle having a transducer for converting the high-frequency signal into vibrations that pulse the pressurized waterjet, the ultrasonic nozzle having a microtip for ultrasonically modulating the pressurized waterjet, the microtip being spaced a distance (a) from an exit plane of an exit orifice of the nozzle designed to have a specific L/d ratio where L represents a length of the exit orifice and d represents a diameter of the exit orifice, wherein the L/d ratio, the frequency f, the amplitude A, the water pressure P, the flow rate Q, and a traverse velocity V_{TR} of the nozzle are predetermined to thereby generate a forced pulsed waterjet whose pulses are specifically designed to prepare a surface of a given material that is spaced at a standoff distance SD from the nozzle so as to produce a substantially uniform and predictable surface roughness on the surface of the material.

In another aspect the pulsed jet can be composed of a liquid other than water. For example, the pulsing jet can be a glycol, a mixture of water and glycol, a cleaning solvent, a dilute acid, an alcohol, an oil, and other suitable fluids.

### BRIEF DESCRIPTION OF THE DRAWINGS

Further features and advantages of the present technology will become apparent from the following detailed description, taken in combination with the appended drawings, in which:

FIG. 1 depicts a forced pulsed waterjet apparatus for use in surface prepping in accordance with embodiments of the present invention;

FIG. 2 depicts the geometry of a microtip and exit orifice in a nozzle of a forced pulsed waterjet apparatus;

FIG. 3 schematically depicts a nozzle with a 90-degree elbow for use in surface prepping the inner cylindrical bore of an engine block;

FIG. 4 schematically depicts a nozzle with dual angled orifices for use in surface prepping the inner cylindrical bore of an engine block;

FIG. 5 schematically depicts a nozzle with two forwardly angled orifices and two rearwardly angled orifices for use in surface prepping the inner cylindrical bore of an engine block;

FIG. 6 schematically depicts a nozzle with two 90-degree orifices for use in surface prepping the inner cylindrical bore of an engine block;

FIG. 7 is a cross-sectional view of a four-orifice ultrasonic nozzle for use in prepping the inner surface of a cylinder bore in accordance with one embodiment;

FIG. 8 is a cross-sectional view of a four-orifice ultrasonic nozzle for use in prepping the inner surface of a cylinder bore in accordance with another embodiment;

FIG. 9 is a cross-sectional view of an ultrasonic nozzle having a magnetostrictive cylindrical core;

FIG. 10 is a cross-sectional view of an ultrasonic nozzle having a magnetostrictive tubular core;

FIG. 11 is a micrograph of a surface profile produced with High Pressure Water Jet; and

FIG. 12 is a micrograph of a surface profile produced with Forced Pulse Water Jet.

It will be noted that throughout the appended drawings, like features are identified by like reference numerals.

### DETAILED DESCRIPTION OF PREFERRED EMBODIMENTS

The present invention pertains to both a novel method of surface preparation of cylinder bores using a pulsed waterjet. A particular example is described utilizing a forced pulsed waterjet (FPWJ), and a novel FPWJ apparatus for surface preparation of cylinder bores materials to predetermined surface roughness parameters.

Underlying Theory of Forced Pulsed Waterjets

To appreciate fully this novel technology, a brief review of the underlying theory of FPWJ is in order to understand why the waterjet impact on a material target is magnified by ultrasonic modulation. Consider as a baseline reference when a steady continuous waterjet (CWJ) impinges normally on any surface to be cut or cleaned, the maximum pressure at the point of impact is called the stagnation pressure pₛ, given by:

Pₛ=½ρV₀²

where V₀=speed of the jet and p=density of water. V₀ is proportional to P, the static pressure at the nozzle inlet (pump pressure)−(frictional losses). However, if a drop or a slug of water strikes the same surface, the initial impact pressure will be much higher. This is the water hammer pressure given by:

Pᵢ=ρV₀C₀

where C₀=speed of sound in water=1524 m/s (5,000 ft/s).

The time during which the water hammer pressure acts is:

$${t}_{i} = \frac{d}{2 {C}_{0}}$$

Where d=nozzle diameter.

From the above equations, it is clear that the amplification of pressure on the surface is:

M=Pᵢ/Pₛ=2C₀/V₀

For example:

TABLE 1

| ps (psi) | 5,000 | 7,500 | 10,000 | 12,500 | 15,000 | 17,500 | 20,000 |
|---|---|---|---|---|---|---|---|
| BAR | 350 bar | 500 bar | 700 bar | 860 bar | 1,030 bar | 1,200 bar | 1,380 bar |
| (MPa) | 34.5 | 52.2 | 69.0 | 103.5 | 103.5 | 121.0 | 138.0 |
| M | 11.6 | 9.5 | 8.2 | 7.3 | 6.7 | 6.2 | 5.8 |

By further example, when the pump is set to operate at 69 MPa, the water hammer pressure on the target would be 566 MPa (82,000 psi). Since the behavior of the material depends on the impact pressure and time, which is determined by the frequency and the nozzle diameter, significant improvement in material erosion, or surface preparation performance, is achieved with the use of forced pulsed waterjets.

The preferred embodiments of both major aspects of the present invention (apparatus and method) will now be described below, by way of example, with reference to the attached drawings.

Apparatus

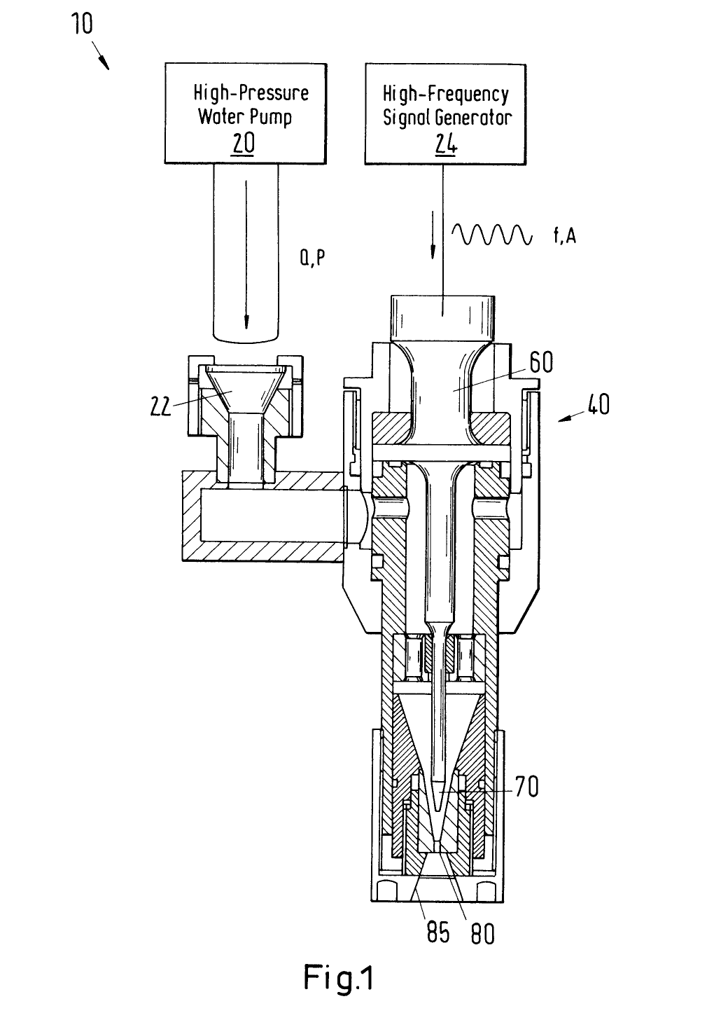

FIG. 1 illustrates a forced pulsed waterjet (FPWJ) apparatus, which is designated generally by reference numeral 10, in accordance with one embodiment of the present invention. This FPWJ apparatus is also referred to herein as an ultrasonic waterjet apparatus. This novel forced pulsed waterjet apparatus is specially designed for prepping a surface that is either metallic or non-metallic.

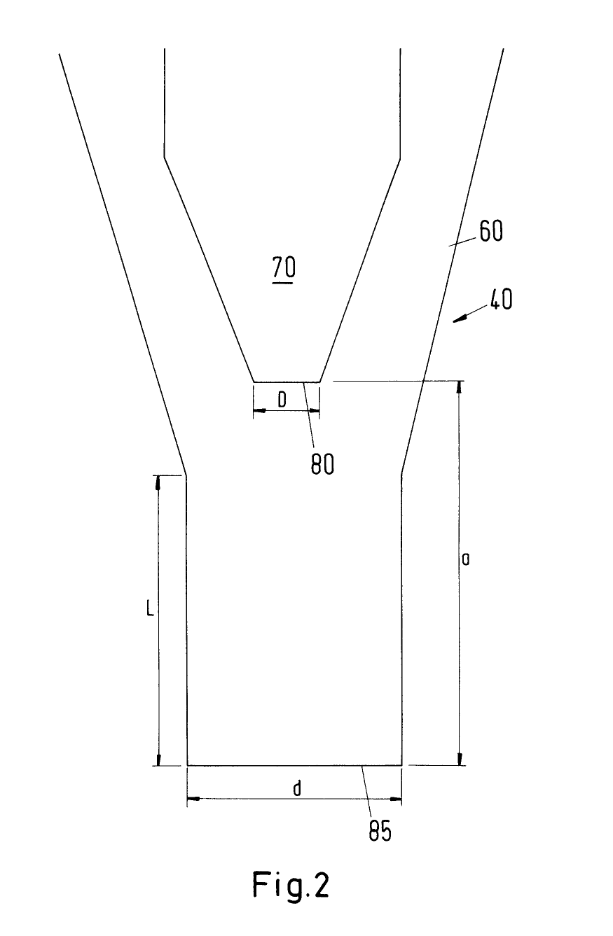

As depicted in FIG. 1, the forced pulsed waterjet (FPWJ) apparatus 10 has a high-pressure water pump 20 for generating a pressurized waterjet having a water pressure P and a water flow rate Q which are connected to water inlet 22. This FPWJ apparatus 10 also has a high-frequency signal generator 24. The high-frequency signal generator 24 could be, for example, the retrofit module (RFM) disclosed in WO/2005/042177. This signal generator 24 can be used for generating a high-frequency signal of frequency f and amplitude A. The frequency and amplitude can be adjusted on the signal generator. The FPWJ apparatus 10 also has an ultrasonic nozzle 40 having a transducer 60 for converting the high-frequency signal into vibrations that pulse the pressurized waterjet. The transducer 60 can be, for example, a piezoelectric transducer or a magnetostrictive transducer. The nozzle 40 has a microtip 70 of diameter D for ultrasonically modulating the pressurized waterjet. This is shown in more detail in FIG. 2, which depicts the geometry of a microtip and exit orifice in a nozzle of a forced pulsed waterjet apparatus. The microtip 70 is spaced a distance ‘a’ from an exit orifice 80 of the nozzle, i.e. from the exit plane of the exit orifice 80. This distance ‘a’ is very important in controlling the performance characteristics of the waterjet. The geometry of the nozzle is also very important. In particular, the ratio L/d is a very important parameter where L is the length of the cylindrical portion of the exit orifice and d is the diameter of exit orifice. Another important ratio is D/d where D is the diameter of the tip and d is the diameter of the exit orifice. Other operating parameters that have effect on the behaviour and performance of the waterjet are the frequency f and amplitude A of the high-frequency signal, the water pressure P and flow rate Q, and a traverse velocity V_{TR} of the nozzle. By taking into account all of these controlling parameters, a suitable forced pulsed waterjet can be generated whose pulses are specifically designed to prep a surface of a given material that is spaced at a standoff distance SD from the nozzle so as to produce a substantially uniform and predictable surface roughness on the surface of the material.

In an embodiment, the waterjet apparatus preferably has an L/d ratio that is between 2:1 and 0.5:1. Based on extensive empirical data, the L/d ratio is believed to be very important in governing the performance of the FPWJ, and in particular, in its ability to predictably and uniformly prep a surface.

In another embodiment, the waterjet apparatus preferably operates with the standoff distance (SD) no greater than 10.0″. For example, it can operate between 0.5″ to 5.0″. These standoff distances allow the pulses to form as discrete slugs downstream of the orifice before they become deformed by the effects of air resistance.

In another embodiment, the waterjet apparatus preferably has an exit orifice diameter d between 0.020″ and 0.100″. The diameter d depends on P and Q.

In still another embodiment, the waterjet apparatus preferably operates at a water pressure P of between 1000 psi and 20,000 psi and more preferably between 5000 psi and 10,000 psi.

In another embodiment, the ratio D/d, where D represents the diameter of the microtip 70 and d represents the diameter of the exit orifice 80, is preferably between 1 and 1.5.

For optimal performance, the exit orifice 80 preferably has either a bell-mouthed shape or a conically converging shape 85 as shown in FIG. 1 to maximally preserve pulses when exiting the nozzle. However, the exit orifice can be straight, for example, having a constant cross-sectional profile such as the cylindrical exit orifice shown in FIG. 2.

This novel ultrasonic waterjet apparatus 10 can be used to prepare surfaces that are either metallic, for example aluminum, steel, stainless steel, iron, copper, brass, titanium, alloys, etc. or non-metallic, for example wood, plastic, ceramic or composites. Virtually any kind of surface roughness or surface finish can be produced by designing a suitable nozzle and by controlling the operating parameters accordingly. This novel technology can be used on surfaces that are flat, for example panels, plates, etc. or curved, for example pipes, tubes, etc., or even odd-shaped parts suitable for forced-pulse water jet surface preparation. For example, as will be presented immediately below, this novel technology can be adapted to prep the inner surfaces of cylinder bores. To do so, a rotating ultrasonic nozzle is used, as will be described below.

Rotating Nozzles for Prepping Cylinder Bores

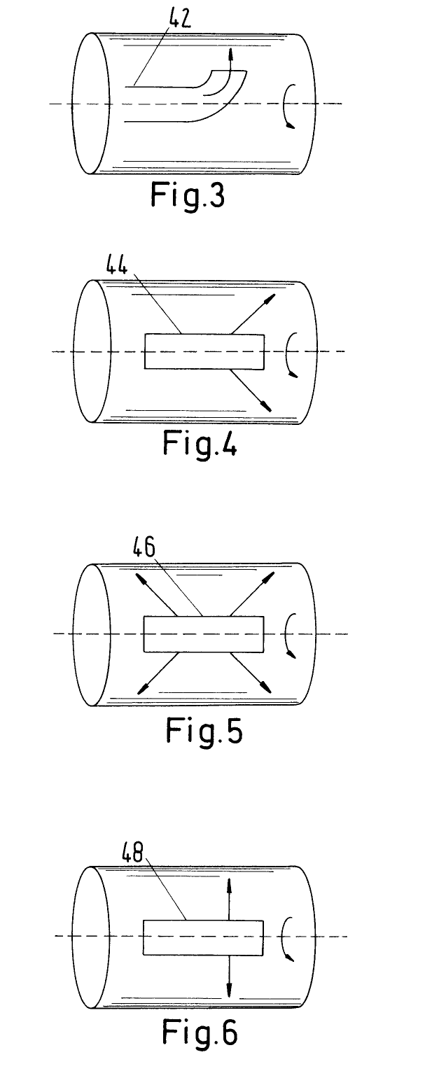

FIGS. 3 to 6 show in schematic form various examples of rotating ultrasonic nozzles that can be used for prepping bores or also the insides of other cylindrical or tubular structures such as, for example, pipes, tubes, etc.

FIG. 3 schematically depicts a nozzle with a 90-degree elbow 42. FIG. 4 schematically depicts a dual-orifice nozzle 44, for example a nozzle with two forwardly angled orifices. FIG. 5 schematically depicts a four-orifice nozzle 46 with two forwardly angled orifices and two rearwardly angled orifices. For example, the forwardly angled exit orifices could be angled at substantially 45-degrees to an axis of displacement of the microtip whereas the rearwardly angled exit orifices could be angled at substantially 135 degrees from the axis of displacement of the microtip. Of course, other angles could be used. FIG. 6 schematically depicts a nozzle with two 90-degree (orthogonally disposed) orifices 48.

It should, of course, be understood that these four examples depicted in FIGS. 3 to 6 are presented merely to illustrate four different ways of designing a nozzle suitable for prepping the inside surface of a cylinder bore. Accordingly, other nozzle designs can be devised to access the inner surface of a small cylinder bore, for example, a cylinder bore of a small internal combustion engine.

In each of these examples, the orifice(s) can be conical, cylindrical, or bell-shaped (“bell mouth”).

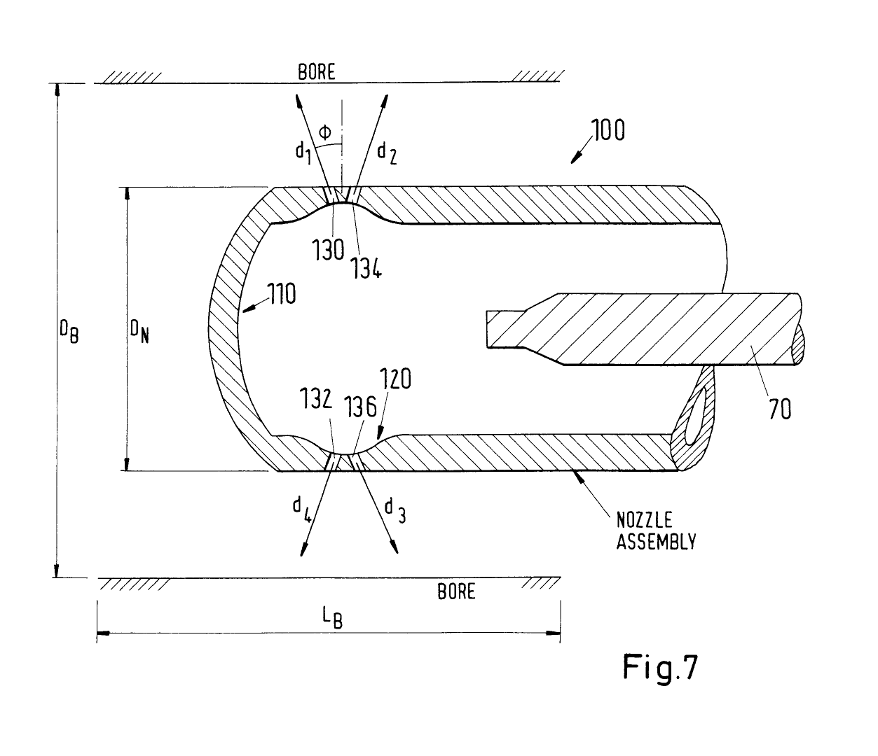

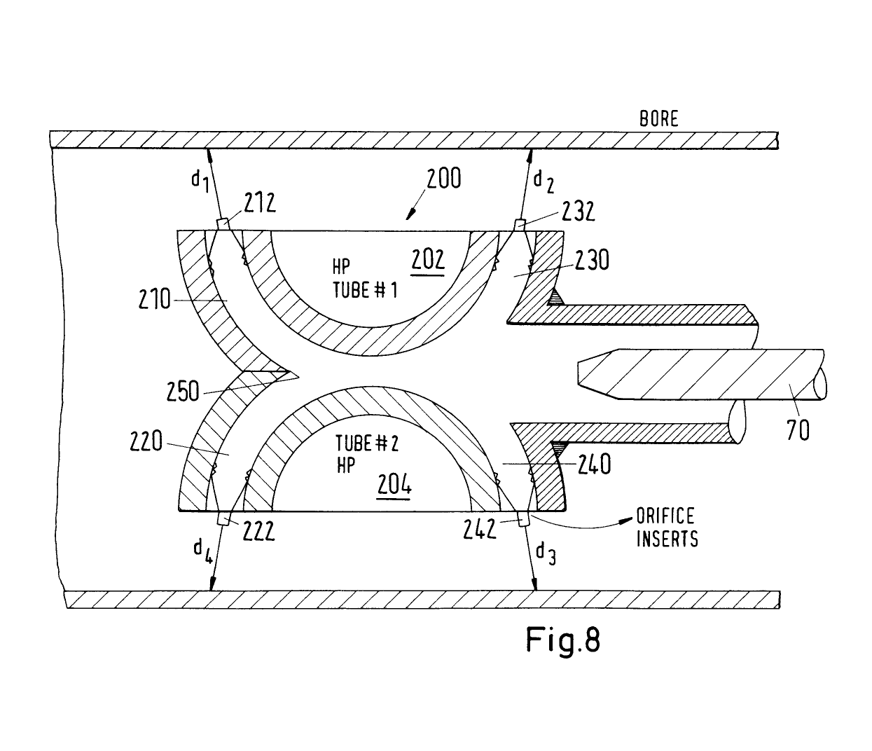

Some more detailed nozzle designs for the rotating four-orifice nozzle introduced in FIG. 5 are presented by way of example in FIG. 7 and FIG. 8.

FIG. 7 is a cross-sectional view of a four-orifice rotating ultrasonic nozzle 100 comprising two forwardly angled exit orifices 130, 132 and two rearwardly angled exit orifices 134, 136. As shown in FIG. 7, the exit orifices have respective diameters d1, d2, d3 and d4. In one embodiment, these diameters can all be the same, such that, for example d1=d2=d3=d4. In another embodiment, these diameters can all be different. In yet another embodiment, the two forwardly angled orifices 130, 132 are the same (d1=d4) while the two rearwardly angled orifices 134, 136 are the same (d2=d3). Similarly, these exit orifices can be angled at a common angle theta (θ and −θ) with respect to the normal, or these orifices can have different angles for each of θ1, θ2, θ3, θ4. Still alternatively, the angles of the forward orifices 130, 132 can be made to be the same while the angles of the rearward orifices 134, 136 can be made to be equal.

In the rotating ultrasonic nozzle of FIG. 7, the inside forward end 110 of the nozzle 100 is rounded (or shaped like a bell mouth) to provide the fluid dynamics required to generate forced pulsed waterjets through each of the four orifices. Likewise, the entry zones 120 proximal to each pair of exit orifices are also rounded or bell-mouthed for optimal flow into the orifices. In this four-orifice configuration, the erosive capacity of the forwardly angled waterjets (egressing through orifices 130, 132) is expected to be greater than that of the rearwardly angled waterjets (egressing through orifices 134, 136). Furthermore, the erosive capacity is a function of whether the nozzle is translating forward or backward. Thus, in an “in-and-out” cycle, the inner surface of the cylinder bore would be subjected, in the forward pass, to the forwardly angled jets and the rearwardly angled jets. In the backward pass, since the nozzle is traveling in the opposite direction, what were previously the rearwardly angled jets egressing through 134 and 136 thus become the forwardly angled jets while what were previously the forwardly angled jets egressing through 130 and 132 thus become the rearwardly angled jets. This nozzle presented in FIG. 7 is designed with exit orifices that have an optimal L/d ratio in the range of 2:1 to 0.5:1, and preferably about 1:1. This ratio of the length of the orifice (L) to its diameter (d) is very important in creating a usable forced pulsed waterjet at the correct power and standoff distance, which in turn, is crucial for achieving the desired surface finish or surface roughness. Another important parameter is the tip-to-orifice length ‘a’ which can be adjusted to generate an optimized forced pulsed waterjet. Optionally, the nozzle is designed by selecting a ratio D/d (where D is the diameter of the microtip) that optimizes performance. Applicant is believed to be the first to recognize the significance of these various parameters and their ratios on the ability of a forced pulsed waterjet to perform precise and predictable surface prepping. The effect of, and the interplay among, these various operating parameters are based on very extensive empirical data that has been collected by Applicant, a small collection of which is presented below to facilitate understanding of this novel technology.

FIG. 8 is a cross-sectional view of another example of a rotating four-orifice ultrasonic nozzle, with this variant being designated by reference numeral 200, that can be used to prep the inner surface of a cylinder bore or, alternatively, of another tubular structure. As depicted in FIG. 8, this nozzle 200 has two forwardly angled orifices 212 and 222 (of diameters d1 and d4, respectively) and two rearwardly angled orifices 232 and 242 (of diameters d2 and d3, respectively). Each of these four orifices is formed at the end of a respective curved conduit as shown in FIG. 8. Specifically, orifice 212 is disposed at the end of conduit 210, orifice 222 is disposed at the end of conduit 220, orifice 232 is disposed at the end of conduit 230, and orifice 242 is disposed at the end of conduit 240.

This nozzle 200 can be constructed by high-pressure welding of two high-pressure tubes that are first sliced as shown in this figure. The joining of these two sliced tubes produces a sharp bifurcation 250. Optionally, the nozzle can include orifice inserts that are secured into each curved conduit to provide the desired geometry at the exit of each curved conduit. The desired geometry is achieved by selecting the values of L and d to achieve an L/d ratio in the range of 2:1 to 0.5:1. Preferably, an L/d ratio of about 1:1 is believed to be optimal. Optionally, the nozzle is designed with a suitable value of ‘a’ (or values ‘a’ in the case of multiple orifices). The ‘a’ value is the distance from the microtip to each respective exit orifice. This ‘a’ value is crucial in ensuring that the pulses develop at the right distance from the nozzle, and thus has an important effect on the standoff distance. Optionally, the ratio D/d may also be configured to provide optimally pulsated waterjets. The value D is the diameter of the microtip. Thus, the ratio D/d is the ratio of the diameter of the microtip to the diameter of the exit orifice. This D/d is preferably in the range of about 1 to 1.5.

### Example

### Prepping Aluminum Cylinder Bores

For prepping bores of cylinders of aluminum engine blocks, the ultrasonic waterjet apparatus is designed with special parameters so that the surface of the cylinder bore of the aluminum internal combustion engine block is prepped to a predetermined surface roughness Rz and Ra to provide good bond strength for subsequent thermal spray coating of the surface, where Ra is a root mean square surface roughness parameter and Rz is an averaged peak-to-peak roughness parameter. Excellent test results were achieved using an exit orifice diameter of 0.04 to 0.093 in, a water pressure of 4.0 to 15 kpsi, a standoff distance of 0.25 to 4.5 in, and a traverse velocity of 1.0 to 50 in/min.

Optimal Ra and Rz values for prepping aluminum cylinder bores with water jets differs from those values obtained by grit blasting. The reason is due to the nature of the actual surface profile. Grit blasting produces shallow under cuts or “hooks” that aids in adhering an applied thermal spray coating to the cylinder bore. In contrast, water jets or fluid jets produce pockets almost like small receptacles into which the coating adheres.

Alternatively, the cylinder bore of the aluminum internal combustion engine block can be prepped to a predetermined surface roughness Ra and Rz which is also expected to provide good bond strength for subsequent thermal spray coating of the surface. It is noted that an Ra value as low as 120 is also believed to be acceptable. These tests were conducted on cylinder bores of a AlSi aluminum engine block, but believed to be applicable, mutatis mutandis, to the bores of other aluminum engine blocks. Extrapolation of these results enables prepping of bores of other types of materials such as those made of other aluminum alloys or even iron.

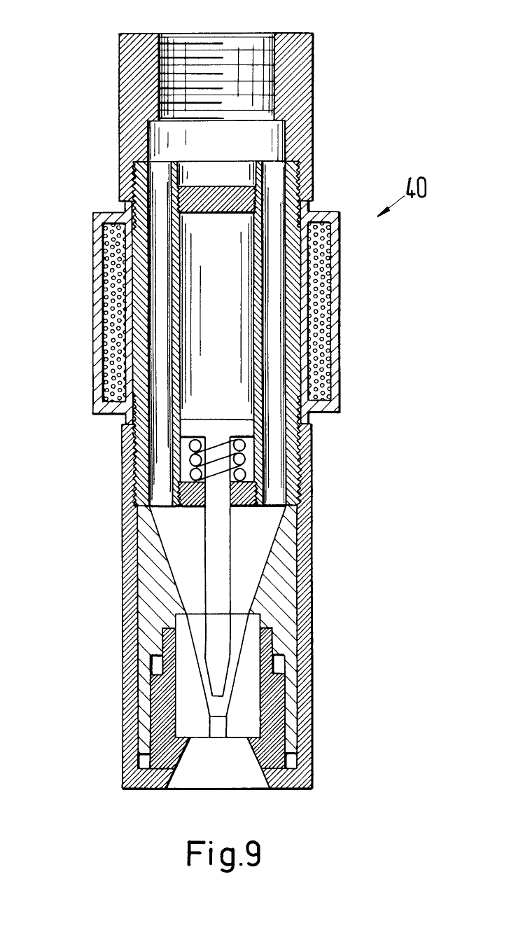

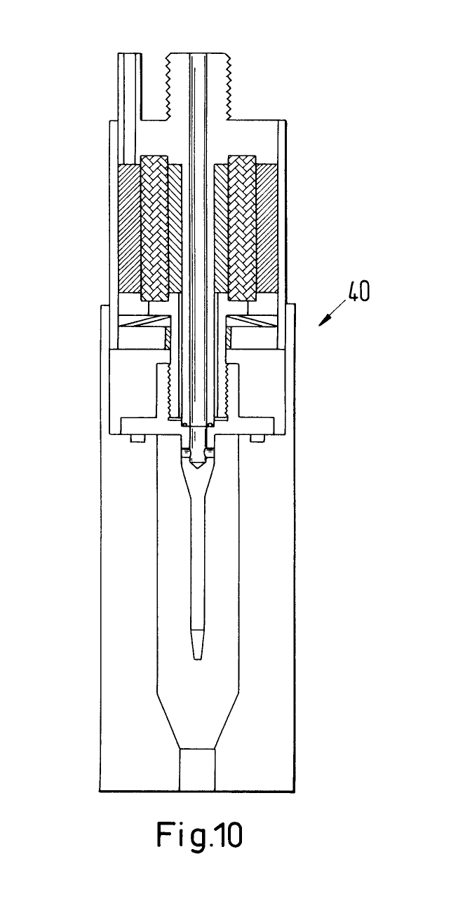

Although the ultrasonic nozzle can employ a piezoelectric transducer, the nozzle can also utilize a magnetostrictive nozzle. FIG. 9 is a cross-sectional view of one example of an ultrasonic nozzle having a magnetostrictive cylindrical core. FIG. 10 is a cross-sectional view of another example of an ultrasonic nozzle having a magnetostrictive tubular core. The nozzles presented in FIG. 9 and FIG. 10 are described more fully in WO/2005/042177 (Vijay).

Method

The present technology also pertains to a novel method of prepping a surface using a high-frequency forced pulsed waterjet. The method comprises steps of generating a high-frequency signal having a frequency f (e.g. 10-20 kHz) using a high-frequency signal generator and applying the high-frequency signal to a transducer (e.g. a piezoelectric transducer or a magnetostrictive transducer) having a microtip (or “probe”) to cause the microtip of the transducer to vibrate to thereby generate a forced pulsed waterjet through an exit orifice of a nozzle having an exit orifice diameter d. The forced pulsed waterjet is caused to impinge upon the surface to be prepped (i.e. the target material) to prepare the surface (of the target material) to within a predetermined range of surface roughness (e.g. Ra and Rz values), wherein the predetermined range of surface roughness is determined by selecting operating parameters comprising a standoff distance (SD), a traverse velocity V_{TR} of the nozzle, a water pressure P, a water flow rate Q, a length-to-diameter (L/d) ratio, where L represents a length of the cylindrical portion of the exit orifice, a parameter ‘a’ representing a distance from the microtip to the exit plane of the exit orifice, the frequency f, and an amplitude A of the high-frequency signal.

Preferably, the L/d ratio is between 2:1 and 0.5:1. For example, excellent results have been achieved with an L/d ratio of 2:1, or with an L/d ratio of 0.5:1. However, best results have been achieved with an L/d ratio of 1:1.

The standoff distance (SD) is preferably no greater than 10.0″ and, more preferably, between 0.5″ to 5.0″. The standoff distance is optimal where the slugs are fully formed. A standoff distance that is too small will be inferior since the pulses have not had enough time to form. Likewise, a standoff distance that is too large will be inferior since the pulses will begin to dissipate due to due aerodynamic forces acting on the slugs. Thus, an optimal SD is instrumental in achieving the desired surface prepping results.

Preferably, the exit orifice diameter d is between 0.020″ and 0.100″, and, more preferably, between 0.040″ and 0.065″. For example, excellent results have been achieved with the exit orifice diameter d=0.040″, or d=0.050″, or d=0.054″ or d=0.065″. A single orifice can be used. Alternatively, dual-orifice or multiple-orifice nozzles can be used. These nozzles can furthermore (optionally) be made to rotate.

The water pressure is preferably between 1000 and 20,000 psi and, more preferably, between 5000 psi and 10,000 psi. As will be appreciated, lower or higher pressures can be used although, preferably, pressures are not to exceed 20 kpsi since the problems associated with UHP (ultra-high pressure jets) begin to manifest themselves.

Optionally, the nozzle can be configured to have a specific ratio D/d where D represents a diameter of the microtip and d represents (as noted above) the diameter of the exit orifice. It has been found that a ratio D/d around 1 provides excellent performance, although very good results are still achieved if the ratio D/d range anywhere from about 1 to 1.5.

As was noted above in the preceding section describing the novel ultrasonic waterjet apparatus, this novel method can be used on either metallic or non-metallic surfaces of any shape or size to achieve a particular surface finish or surface roughness. By selecting the operating parameters, a uniform and predictable surface finish can be achieved. In other words, this surface finish is “predetermined” by the various operating conditions and by the geometry of the nozzle, i.e. it is reproducible, controllable and predictable.

Prepping Cylinder Bores of Aluminum Engine Blocks

In one specific implementation of this novel technology, this innovative method can be used to prep the inside surfaces of cylinder bores for aluminum alloy internal combustion engines. The cylinder bores can be prepped to very exacting surface roughness characteristics that facilitate subsequent application of thermal spray coating that is used to improve the performance of reciprocating piston engines in terms of wear, friction and exhaust emissions.

This method can be implemented using a single orifice nozzle, a dual-orifice nozzle or a nozzle having multiple orifices (e.g. four orifices). Preferably, this method can be implemented using either the nozzle presented in FIG. 7 or the one presented in FIG. 8. Variations on these nozzle designs can, of course, be used as well. The forced pulsed waterjet can be conveyed through one or more curved orifices or conduits (or “elbows”) whereby the forced pulsed waterjet exits substantially orthogonally to thereby prep an inner surface of the cylinder bore. The orifices can also be angled at various angles to achieve different results. This method can be optimally performed by using a nozzle that has exit orifices that have either a bell-mouth shape for optimal jet performance, although this method can also be performed using conical orifices or plain cylindrical orifices.

The method of surface prepping the inner surfaces of the cylinder bores can be advantageously implemented using a nozzle that comprises two forwardly angled exit orifices and two rearwardly angled exit orifices. In one preferred embodiment, the forwardly angled exit orifices are angled at substantially 45-degrees to an axis of displacement of the microtip whereas the rearwardly angled exit orifices are angled at substantially 135 degrees from the axis of displacement of the microtip. In this configuration, four jets impinge concurrently on the cylinder bores. Since the engine block is preferably held stationary in a jig or other gripping device, the nozzle is rotated at a constant rotational velocity, e.g. at 1000-2000 RPM while being translated into and out of the bore along an axis aligned with the axis of the cylinder bore at a traverse velocity V_{TR}. The traverse velocity is preferably set to complete one cycle of surface prepping in a desired timeframe. For example, if the surface prepping is to be completed in 1 minute, and the bore is 5 inches long, then the VTR should be 10 in/min so that the nozzle can complete one cycle (two passes, i.e. in and out) within the allotted time.

An alternative measure of a surface's suitability for application of a coating is to consider not only the absolute values of Ra and Rz but their ratio, Rz/Ra. Thus, this method can be used to prep a cylinder bore of an aluminum internal combustion engine block (e.g. an AlSiCu aluminum alloy engine block) to a predetermined surface roughness ratio.

Optional Abrasive Entrainment

In a variant of this novel method, an abrasive can be entrained into the waterjet to provide greater erosive capacity. The abrasive can be from geological origins such as zeolite or garnet or man made such as alumina and similar ceramics. Alternatively, thermal spray particles can be used for prepping. In this case, the thermal spray particles are partially embedded into the material during prepping. Subsequently, during coating, the same thermal spray particles are coated onto the prepped surface.

This abrasive can be entrained by injecting the abrasive into the pulsed waterjet downstream of the microtip (probe) to avoid eroding the microtip. A mixing chamber can be used downstream of the microtip to ensure that the abrasive is fully and uniformly mixed into the waterjet without disrupting or corrupting the waterjet pulses. In other words, the discrete slugs of water must remain intact after the abrasive mixing/entrainment occurs.

Optional Dual-Mode Operation

Advantageously, the forced pulsed waterjet machine can optionally operate in two modes. That is, if the ultrasonic power is turned off, the machine will work as a conventional waterblaster with a continuous plain waterjet. This can be useful for regular blasting jobs or for the removal of soft coatings. If hard coatings are encountered, activating the ultrasonic generator will enable removal of these coatings. The dual-mode operation thus enables a user to switch between pulsed and continuous waterjets as desired.

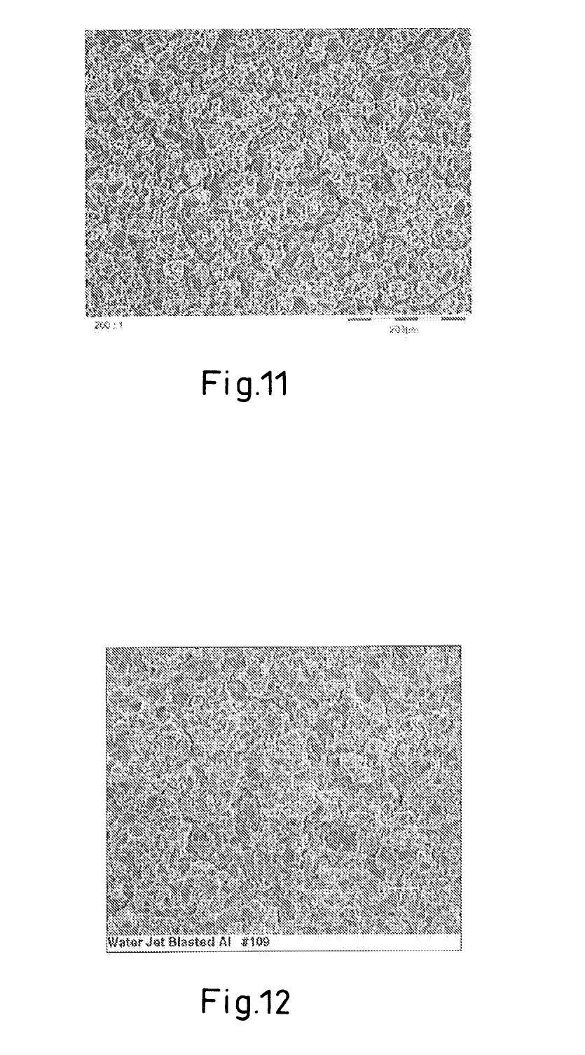

FIGS. 11 and 12 show comparative surface profiles prepared using HPWJ and FPWJ, respectively on the surface of identical cylinder bores. The HPWJ used an application pressure of 41,300 psi to produce the surface shown in FIG. 11. In contrast, FPWJ used an application pressure of 10,000 psi is shown in FIG. 12. The measured Ra and Rz values were roughly the same, and as seen in the figures, the appearance of the surfaces are so similar it is difficult to determine which is HPWJ and which is FPWJ.

The embodiments of the invention described above are intended to be exemplary only. As will be appreciated by those of ordinary skill in the art, to whom this specification is addressed, many obvious variations can be made to the embodiments present herein without departing from the spirit and scope of the invention. The scope of the exclusive right sought by the applicant is therefore intended to be limited solely by the appended claims.

1. A method of prepping a surface of a cylinder bore using a pulsed waterjet, the method comprising steps of:
generating a signal having a frequency f using a signal generator;
applying the signal to generate a pulsed waterjet through an exit orifice of a nozzle having an exit orifice of diameter d and having a cylindrical portion of the exit orifice of length L; and
causing the pulsed waterjet to impinge upon the surface of the cylinder bore to be prepped to prepare the surface to within a predetermined range of surface roughness, wherein the predetermined range of surface roughness is determined by selecting operating parameters comprising a standoff distance (SD), a traverse velocity V_{TR} of the nozzle, a water pressure P, a water flow rate Q, an orifice length-to-diameter (L/d) ratio, the frequency f, and an amplitude A of the signal.

2. The method of claim 1, wherein the signal is generated using at least one of an internal mechanical flow modulator, a Helmholtz oscillator, a self-resonating nozzle, an ultrasonic nozzle and an acoustic transducer.

3. The method as claimed in claim 1 wherein the L/d ratio is between 2:1 and 0.5:1.

4. The method as claimed in claim 1 wherein the standoff distance (SD) is no greater than 10.0″.

5. The method as claimed in claim 1 wherein the water pressure is between 1000 psi and 20,000 psi.

6. The method as claimed in claim 1 further comprising rotating the nozzle at a rotational speed of 1000-2000 RPM.

7. The method as claimed in claim 1 further comprising a step of entraining an abrasive into the waterjet.

8. The method as claimed in claim 1, wherein the forced pulsed waterjet is a liquid.

9. The method as claimed in claim 8, wherein the liquid comprises at least one of water, a glycol, water plus a glycol, a cleaning solvent, a dilute acid, an alcohol and an oil.

10. A pulsed waterjet apparatus, the apparatus comprising:
a water pump that generates a pressurized waterjet having a water pressure P and a water flow rate Q;
a signal generator that generate a signal of frequency f and amplitude A to the pressurized waterjet creating a pulsed waterjet; and
a nozzle that receives the pulsed waterjet, the nozzle having an exit orifice designed to have a specific L/d ratio where L represents a length of the exit orifice and d represents a diameter of the exit orifice, wherein the L/d ratio, the frequency f, the amplitude A, the water pressure P, the flow rate Q, and a traverse velocity V_{TR} of the nozzle are predetermined to thereby generate a pulsed waterjet whose pulses are designed to prep a surface of a given cylinder bore material that is spaced at a standoff distance SD from the nozzle.

11. The waterjet apparatus of claim 10 wherein the signal is generated using at least one of an internal mechanical flow modulator, a Helmholtz oscillator, a self-resonating nozzle, an ultrasonic nozzle and an acoustic transducer.

12. The waterjet apparatus as claimed in claim 10 wherein the L/d ratio is between 2:1 and 0.5:1.

13. The waterjet apparatus as claimed in claim 10 wherein the standoff distance (SD) is no greater than 10.0″.

14. The waterjet apparatus as claimed in claim 10 wherein the water pressure is between 1000 psi and 20,000 psi.

15. The waterjet apparatus as claimed in claim 10 wherein the nozzle is rotatable at a rotational speed of 1000-2000 RPM.

16. The waterjet apparatus of claim 10, wherein the pulsed waterjet further comprises an abrasive.

17. The waterjet apparatus of claim 10, wherein the forced pulsed waterjet is a liquid.

18. The waterjet apparatus of claim 17, wherein the liquid comprises at least one of water, a glycol, water plus a glycol, a cleaning solvent, a dilute acid, an alcohol and an oil.
